(19) United States
(12) Patent Application Publication
(10) Pub. No.: US 2004/0188429 A1
(43) Pub. Date: Sep. 30, 2004

(54) Distributed microwave system

(76) Inventors: Kurt Hakan Carlsson, Norrkoping (SE); Ulf Erik Nordh, Norrkoping (SE); Wilhelm Elkhart Braunisch, Kimstad (SE); Carolyn L. Slone, St. Joseph, MI (US)

Correspondence Address: MCGARRY BAIR PC, 171 MONROE AVENUE, N.W., SUITE 600, GRAND RAPIDS, MI, 49503, US

(21) Appl. No.: 10/708,533

(22) Filed: Mar. 10, 2004

Related U.S. Application Data
(60) Provisional application No. 60/320,002, filed on Mar. 11, 2003.

(51) Int. Cl. H05B 6/70

(52) U.S. Cl. 219/697; 219/689

(57) ABSTRACT

A distributed microwave system comprising a single microwave source that can be used to supply one or more microwave-using devices. The microwave source is located remotely from the microwave-using devices and connected thereto by a microwave conduit.

### CROSS-REFERENCE TO RELATED APPLICATION

This application is a non-provisional of provisional application No. 60/320,002 filed Mar. 11, 2003, now pending.

### FIELD OF THE INVENTION

The invention generally relates to a distributed microwave system comprising a single microwave generator that supplies microwaves to one or more microwave-using devices located remotely from the microwave generator. In one implementation, the invention relates to using the distributed microwave system in the form of a cup warmer in a vehicle where the cup warmer is a microwave-using device that is supplied microwaves by a microwave generator located remotely from the cup warmer.

### DESCRIPTION OF THE RELATED ART

Drinking beverages, such as coffee, soda, water, while in a vehicle has become commonplace, if not an expected part of the vehicle culture. In fact, vehicles are constantly being designed and redesigned to accommodate different size beverage containers and to accommodate more beverage containers. Many vehicles are marketed based on the number of cup holders in the vehicle.

For consumers of hot beverages, such as coffees, the consumption of the hot beverages in cars has a disadvantage in that there is currently no easy way to keep the hot beverage warm or to reheat the hot beverage if it cools below the desired temperature. This is especially a problem on trips were the consumers are in the vehicle for extended periods of time.

Some vehicles have attempted to provide a cup holder that contains a warmer in the form of a thermoelectric device for keeping the contents of the cup warm. The thermoelectric devices previously used in vehicles generally only had sufficient thermal output to keep the contents of the cup warm and do not have sufficient thermal output to reheat the contents of the cup once the contents cooled.

Therefore, there is still a desire to have a cup warmer in a vehicle that is not only capable of maintaining the warmth of the contents of the cup, but can also reheat the contents of the cup if the contents are allowed to cool.

In addition to having a cup warmer that is capable of reheating the contents of the cup, vehicle users also have a desire to reheat food items while in the vehicle. Again, this is especially desirable for long trips where the vehicle users are in the car for extended periods of time, especially during mealtimes. The cooking or heating of food in the vehicle is especially useful when the vehicle users include small children who's boredom can be averted by a parent providing them with heated food or a warmed snack.

### SUMMARY OF THE INVENTION

The invention relates to a vehicle in combination with a distributed microwave cooking system for cooking and warming food items and beverages within the vehicle. The distributed microwave cooking system comprises a microwave cooking element that is located within the vehicle and accessible by a user of the vehicle. A microwave generator is located within the vehicle and is remotely spaced from the microwave cooking element. A microwave conduit connects the microwave generator to the microwave cooking element such that the microwaves generated by the microwave generator are directed to the microwave cooking element through the microwave conduit to cook an item with the microwave cooking element.

The microwave conduit can comprise a coaxial cable that carries the microwaves from the microwave generator to the cooking element. The microwave conduit can further comprise a waveguide that is connected to the output of the microwave generator and to one end of the coaxial cable. The waveguide directs the microwaves from the microwave generator to the coaxial cable for distribution to the cooking element.

The distributed microwave cooking system can include multiple microwave cooking elements located in the vehicle and connected thereto through the microwave conduit. In such a configuration where the microwave generator supplies multiple microwave cooking elements, the microwaves can be distributed to the multiple cooking elements in different manners. One manner of connecting the multiple cooking elements to the microwave generator is to provide the coaxial cable with a switch having multiple outputs. A feeder coaxial cable is then connected to each of the outputs into a corresponding cooking element. Another manner is to provide the waveguide with multiple channels and have a single coaxial cable extending from each of the channels of the waveguide and connecting to a corresponding cooking element.

Although the cooking element can be located anywhere in the vehicle, it is preferred that the cooking element be located within the passenger compartment. Similarly, the microwave generator can be located anywhere within the vehicle. However, it is preferred that the microwave generator be located in a remote location in the vehicle since it is not necessary for the user to have access to the microwave generator. Areas such as the trunk or engine compartment of the vehicle are the preferred location for the microwave generator.

The cooking element can take on several different forms. One form for the cooking element is a selectively closable cavity. A selectively closable cooking cavity is ideal for being located within several traditional structural features of the vehicle. For example, the selectively closable cooking cavity can be located within a center console, armrest, dashboard, or glove box of the vehicle. Another form for the cooking cavity is a heating plate that is microwave lossy and which radiates heat when exposed to the microwaves.

If the selectively closable cooking cavity is located within the passenger compartment and is desired to hold a cup, then it is preferred that the cooking element be formed in a housing having an open-top recess that defines the cooking cavity and a cover that is movably mounted to the housing for selectively closing the open-top recess. A cup support can be provided in the open-top recess and is used to support the bottom of a cup which is placed within the cooking cavity.

In a cup-warming configuration such as the open-top cooking cavity, the microwaves can be supplied thereto by different methods. One method is for the coaxial cable carrying the microwaves to have an inner conductor, an portion of which can extend into the open-top cooking cavity to form an antenna for transmitting the microwaves into the cooking cavity to directly radiate the contents of the cup. Another method is for the open-top cooking cavity to further include a heating element that is directly connected to the coaxial cable and is made from a microwave lossy material such that the heating element is heated upon receipt of the microwaves. Preferably, the cup support is one in the same as the heating element.

Various sensors can be used to and in the warming and heating of the food items, especially with the warming and heating of the beverages and a cup. For example, a temperature sensor can be located within the open-top cooking cavity to help in determining the temperature of the contents of the cup as it is heated. One such temperature sensor can be an infrared sensor that is located on the cover at a position such that the sensor overlies the top of the cup. Another sensor is that of a temperature probe that can be located within the open-top cooking cavity such that it extends into the liquid in the cup when the cover is closed.

Another useful sensor is that of a load detection sensor for determining if the cup contains sufficient liquid for warming or heating. The load detection sensor can be a weight sensor that detects the weight of the cup and its contents. The load detection sensor can also be a microwave sensor that detects the amount of microwaves not absorbed by the load, which can be used to indicate the size of the load.

In another aspect, the invention relates to a microwave cup warmer for a vehicle and which comprises a microwave cooking element for warming the contents of a cup therein. A microwave generator is located remotely from the microwave cooking element. A microwave conduit connects the microwave generator to the microwave cooking element such that the microwaves generated by the microwave generator are directed to the microwave cooking element through the microwave conduit to cook an item with the microwave cooking element.

In yet another aspect, the invention relates to a distributed microwave cooking system, which comprises a microwave generator having an output for providing a single source of microwave energy. Multiple cooking elements are provided and are spaced remotely from the microwave generator. A microwave conduit connects each of the cooking elements to the microwave generator in such a manner that the microwave energy generated by the microwave generator is distributed to each of the multiple cooking element through the microwave conduit.

The microwave conduit can comprise a coaxial cable that carries microwaves from the microwave generator to at least one of the cooking elements. The microwave conduit can further comprise a waveguide that is connected to the output of the microwave generator and one end of the coaxial cable to direct the microwaves from the microwave generator to the coaxial cable for distribution to at least one of the cooking elements.

In such a configuration where the microwave generator supplies multiple microwave cooking elements, the microwaves can be distributed to the multiple cooking elements in different manners. One manner of connecting the multiple cooking elements to the microwave generator is to provide the coaxial cable with a switch having multiple outputs. A feeder coaxial cable is then connected to each of the outputs and a corresponding cooking element. Another manner is to provide the waveguide with multiple channels and have a single coaxial cable extending from each of the channels of the waveguide and connecting to a corresponding cooking element.

The microwave cooking elements can have different configurations. One suitable configuration is that the microwave cooking element is a selectively closable cooking cavity that can receive an item or container for cooking. Another suitable configuration is that of a microwave heating element that is heated upon receipt of the microwaves. The selectively closable cooking cavity can be used in conjunction with the microwave heating element. In such a configuration, the microwave heating element would be placed within the microwave cooking cavity.

The microwave cooking cavity can be incorporated into many well-known structures. For example, the cooking cavity could be that cavity of a traditional microwave, a traditional oven, or of a warming drawer. Also, in the context of a vehicle, the microwave cooking cavity could be formed in an arm rest, console, dashboard, or glove box. The microwave heating element could be used in any of these environments also.

### BRIEF DESCRIPTION OF THE DRAWINGS

FIG. 1 is a top, rear perspective view of a vehicle incorporating a distributed microwave cooking system according to the invention, including cooking cavities in the form of a cup holder and a glove box, which are supplied by a remotely located microwave generator.

FIG. 2 is a schematic view of the plan form for the vehicle of FIG. 1 and illustrating the location of the microwave generator and cooking cavities, along with their connection by microwave conduits according to the invention.

FIG. 3 is a schematic illustration of a microwave generator in the form of a magnetron in combination with a microwave conduit in the form of a waveguide being in combination with a coaxial cable for distributing the microwaves from the magnetron to the cooking cavities.

FIG. 3A is similar to FIG. 3, except that is shows a coaxial cable switch attached to the coaxial cable and feeder coaxial cables extending therefrom.

FIG. 4 is a schematic illustration of the interface between the coaxial cable and the cup warming cooking cavity.

FIG. 5A is a sectional view of a first alternative configuration for the cup warmer cooking cavity formed in a console of a vehicle, with the cavity being defined by the console housing and a movable cover for the housing, and incorporating an infrared temperature sensor.

FIG. 5B is a sectional view of a second alternative configuration for the cup warmer cooking cavity formed in a console of the vehicle, and incorporating a temperature probe temperature sensor.

FIG. 6 is a schematic illustration of a load sensor for determining the load of the contents in the cup warming cooking cavity in the form of a sensor for determining the unused portion of the microwaves.

FIG. 7A is a schematic illustration of an alternative load sensor in the form of a weight sensor shown in a first position.

FIG. 7B is a schematic illustration identical to FIG. 7A and showing the weight sensor in a second position.

FIG. 8 is a front view of a traditional kitchen incorporating a microwave distribution system according to the invention.

### DESCRIPTION OF THE PREFERRED EMBODIMENT

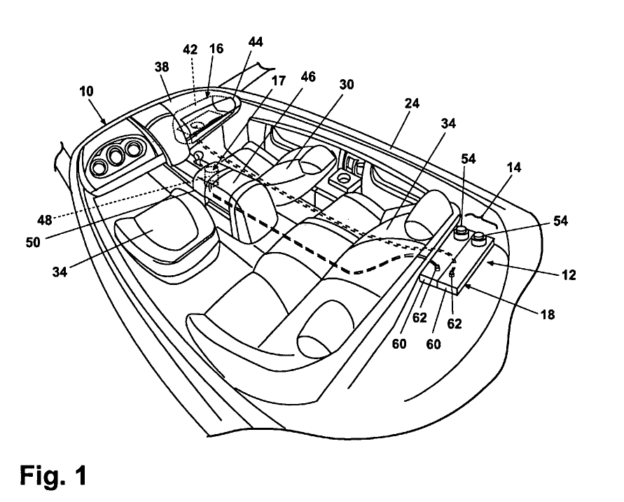

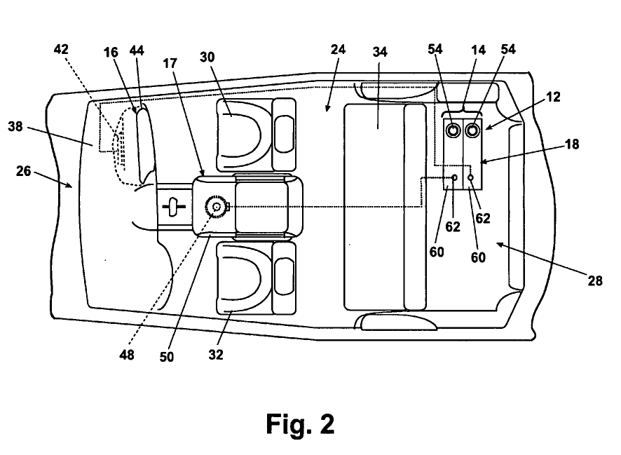

FIGS. 1 and 2 illustrate a vehicle 10 incorporating a distributed microwave system 12 comprising a microwave generator 14 operably coupled to cooking elements 16, 17 by a microwave conduit 18. The microwave generator 14 is remotely located from the cooking elements 16, 17 and is used to generate microwaves that are supplied to the cooking elements 16,17 by the microwave conduit 18 such that the cooking elements can cook items as desired by a user of the vehicle 10. For purposes of this disclosure, in addition to their normal meeting, the terms cook or cooking include the warming and heating of items.

As illustrated, the vehicle 10 is a traditional sedan configuration comprising a passenger compartment 24 located between an engine compartment 26 and a trunk 28. The passenger compartment 24 includes individual front seats 30, 32 and a bench rear seat 34. A center console 36 incorporating the cooking element 17 is located between the spaced front seats 30, 32. A dashboard 38 is located in front of the front seats 30, 32 and adjacent the engine compartment 26 and houses the cooking element 16. The rear seat 34 is located adjacent the trunk 28. While the invention is described in the context of a sedan configuration, the invention is applicable to any type of vehicle.

As shown in FIGS. 1 and 2, the microwave generator 14 is located in the trunk of the vehicle, remotely from the cooking elements 16, 17, since it is not anticipated that the user will need to frequently access the microwave generator 14. The microwave generator 14 can be located in other remote portions of the vehicle, such as the engine compartment 26. Another suitable location for the microwave generator is beneath the front seats 30, 32 or rear seat 34.

The cooking elements 16, 17 can take many forms. It is anticipated that the preferred forms will include a cooking cavity in which food items can be placed for cooking and/or a heating element on which food items can be placed for cooking. It is contemplated that a heating element can be used in combination with a cooking cavity.

The cooking elements 16, 17 are illustrated as being of the cooking cavity type. The cooking element 16 is formed by a cooking cavity 42 that is located within the dashboard 38 of the vehicle 10 at the traditional location for a glove box, with a door 44 being provided for selectively closing the cooking cavity 42. In this manner, the cooking cavity 42 can replace a traditional glove box and function as a traditional microwave, located within the vehicle for cooking foods disposed therein. The cooking element 16 is essentially a small capacity microwave oven, which is well suited for warming and heating cooked and uncooked foods, and is especially useful for making microwave popcorn.

The cooking element 17 is also of the cooking cavity type and is formed by a cooking cavity 48 formed in the center console 36 of the vehicle, with a cover 50 of the console functioning as a door for selectively closing the cooking cavity 48. It is anticipated that the cooking cavity 48 will be positioned in the center console 36 at the traditional location for a cup holder. Therefore, the cooking cavity 48 can perform the dual role of being a cup holder in addition to cooking the contents contained within the cup. A preferred use of the cooking cavity 48 would be to maintain the temperature of the contents of the cup or reheat the contents of the cup is desired by the user.

Although the cooking cavity 17 is shown in the center console, such a cooking cavity could be located elsewhere in the vehicle, such as an arm rest, seat, and dashboard. There could also be multiple cup warmer cooking cavities located throughout the passenger compartment and even in the trunk or vehicle compartment.

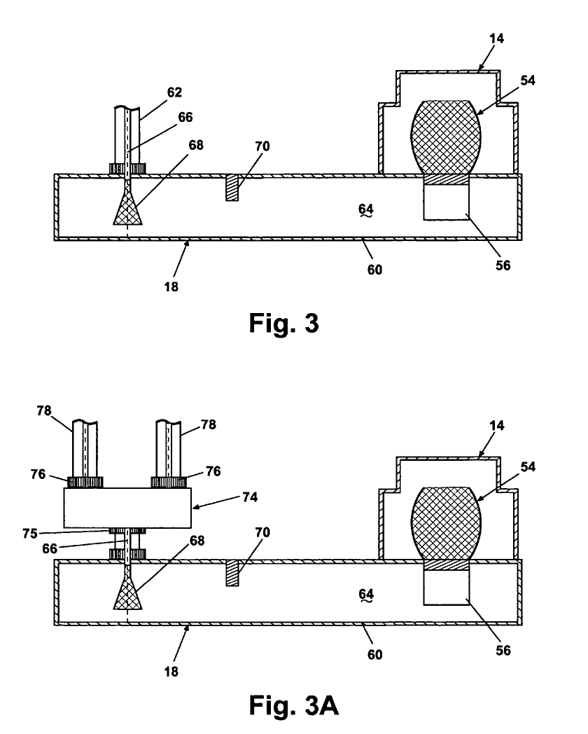

FIGS. 3-5 illustrate in greater detail the structure of the components of the distributed microwave system 12. The microwave generator 14 is formed by a pair of magnetrons 54, with each magnetron supplying microwaves for one of the cooking elements 16 and 17. The conduit comprises a pair of waveguides 60 and coaxial cables 62 for coupling each of the magnetrons 54 to the corresponding cooking element 16, 17. In essence, each cooking cavity is supplied by its own combination of magnetron 54, waveguide 60, and coaxial cable 62. Thus, only one of the combinations will be described in detail.

FIG. 3 shows the details of the magnetron 54, waveguide 60, and coaxial cable 62. The magnetron 54 is traditional and well known, having an antenna 56. The magnetron 54 generates the microwaves, which are then transmitted through the antenna 56 into the conduit 18 for distribution to the cooking element 16,17.

While the microwave generator 14 is illustrated as being a traditional magnetron 54, it is within the scope of the invention for other microwave generators 14 to be used. For example, solid-state microwave generators are well known can also be used.

The microwave conduit 18 comprises a waveguide 60 and a coaxial cable 62. The waveguide 60 is of a traditional construction that is well-known in the art. The waveguide 60 defines an interior channel 64 into which the antenna 56 of the magnetron 54 extends near one and of the channel 64. The interior dimensions of the channel 64 can be selected such that the waveguide will propagating a particular mode for the microwave generated by the magnetron. Preferably, channel 64 is sized such that propagated mode is TE 10.

The coaxial cable 62 has an outer conductor (not shown) and an inner conductor 66 that extends into the channel 64 of the waveguide 60. The inner conductor 66 has an end portion 68 that is tapered and extends into the channel 64 of the waveguide 60. The end portion 68 functions as an antenna to receive the microwaves transmitted from the antenna 56 of the magnetron 54. The tapered shape of the end portion 68 improves the performance of the inner conductor 66 as a receiving antenna. Preferably, the end portion 68 of the inner conductor 66 is located approximately ¼ wavelength away from the downstream end of the waveguide 60.

An impedance tuner 70 is located within the channel 64 of the waveguide 60 between the antenna 56 of the magnetron 54 and the tapered portion 68 of the inner conductor 66. The location and size of the impedance tuner 70 can be varied as need be.

FIG. 3A illustrates another method for distributing the microwaves from the microwave generator 14 to the multiple cooking element 16, 17. Instead of using a separate magnetron 54 for each cooking element 16, 17, a single magnetron 54 can be used to supply both cooking elements 16, 17. In such a configuration only a single waveguide 60 is required. A switch 74 has a single input 75 that is mounted to the coaxial cable 62 to route the microwaves to the selected cooking element 16, 17. The switch has multiple discrete signal outputs 76. The switch 74 effectively separates the microwave signal passing through the coaxial cable 62 into multiple discrete signals exiting the outputs 76. Feeder coaxial cables 78 extend from the outputs 76 and are coupled to the corresponding cooking element 16,17 to supply them with the microwaves.

The switch 74 would be controlled by the controller used to control the cooking within the cavities. Any suitable controller used to control a microwave would work for the invention as long as it incorporated the ability to control the switch 74 and direct the output to the correct cooking element.

Although the switch 74 is shown as having only two outputs, it is within the scope of the invention for the switch 74 to have any number of outputs. For example, the switch could have a single input (In1) and multi outputs (out1, out2, out3, . . . ). To each output there can be a related control input (c1, c2, c3, . . . ), to which is fed a low voltage control signal, permitting the switch to be electronically controlled. A low voltage control signal could be used to determine if an output is connected or disconnected to the input.

Preferably, only one output would be active at a time. Thus, all of the power from the magnetron would be sent to one of the cooking elements 16, 17. The active output can be selected by setting the control signal to “High”. If high power is going into the input “In1” and “c2” is “High” and all others “c1”, “c3” . . . are “Low”, then “out2” delivers the power from “In1” and zero power from the other outputs, “out1, “out3”, etc.

The switch 74 is realized by semiconductors, transistors with sufficient power handling capability. One example could be a MESFET transistor, especially one using silicon carbide technology.

While it is preferred for the switch 74 to supply only one of the outputs, it is within the scope of the invention for the switch 74 to supply multiple outputs. The disadvantage of such a structure is that the output from the single microwave generator will be split between the multiple outputs, which reduces the power delivered to each cooking element. The reduction in power will increase the cooking times all else being equal.

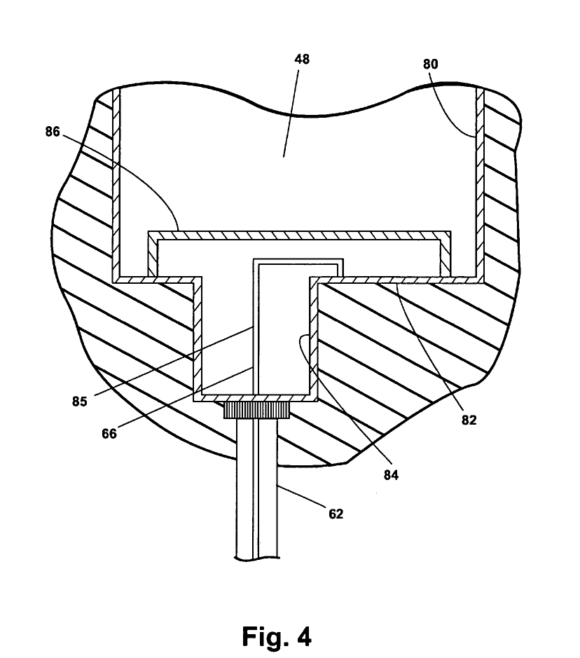

FIG. 4 illustrates the connection of the coaxial cable 62 to the cooking cavity 48 of the cup warmer cooking element 17. The cooking cavity 48 comprises a peripheral sidewall 80 that extends upwardly from a bottom wall 82. A recess 84 is formed in a bottom wall 82 and mounts the end of the coaxial cable 62. The inner conductor 66 of the coaxial cable extends through the recess 84 and has a terminal end that is fixedly mounted to the bottom wall 82. The portion of the inner conductor 66 that extends into the recess 84 functions as an antenna 85 for transmitting microwaves into the cooking cavity 48 for cooking the contents of the cup placed therein.

A cup support 86 extends from the bottom wall 82 and is preferably located above the antenna 85. The cup support 86 supports the bottom of a cup placed within the cooking cavity 48 above the antenna 85. As illustrated in FIG. 4, it is anticipated that the cup support 86 will be made of a microwave transparent material such that it does not impair the transmission of the microwaves throughout the cooking cavity 48. However, it is within the scope of the invention for the cup support 86 to be made from a microwave lossy material and the coaxial cable 62 be coupled directly to the cup support such that the microwave energy will be transmitted directly into the cup support 86, which will result in the heating of the cup support 86. The heated cup support 86 can be used to heat the contents in the cup placed thereon by conduction and convection.

While FIG. 4 illustrates the connection of the coaxial cable 62 to the cooking cavity of the cup warmer cooking element 17, a similar connection can be used to connect the coaxial cable 62 to the cooking cavity 42 of the cooking element 16. For that matter, the connection of the coaxial cable to the cooking cavity as illustrated in FIG. 4 can be used for any cooking cavity type configuration.

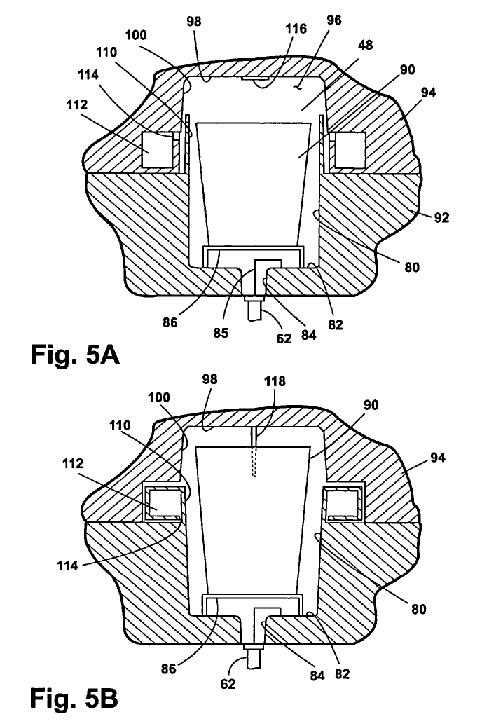

Referring now to FIGS. 5A and 5B, alternative configurations for the cooking cavity 48 are illustrated. The configuration as illustrated in FIG. 5A illustrates an open top cavity 48 defined by the peripheral wall 80 extending from the bottom wall 82, which has a recess 84 through which the antenna 85 passes as illustrated in FIG. 4. The height of the recess 48 is approximately equal to or slightly greater than the greatest anticipated height of a cup 90 placed within the open-top cooking cavity 48.

The cooking cavity 48 is formed in a base portion 92 of the console 36. The console 36 also includes a movable portion 94 forming the cover 50 for the cooking cavity 48. The movable portion 94 includes an open-bottom recess 96 comprising a top 98 from which depend a peripheral wall 100.

A seal is provided to prohibit the escape of microwaves from the cooking cavity 48 when the movable portion is in the closed position as illustrated in FIG. 5A. The seal is formed by a planar portion or rim 110 of the peripheral wall 80 in combination with a pocket 112 formed in the movable portion 94. The pocket 112 includes multiple openings 114, which expose the pocket 112 to the cooking cavity 48. The planar portion 110 of the peripheral wall 80 has a height that extends beyond the openings 114. The pocket 112 is sized such that it acts as a ¼ wave choke for the microwaves.

A temperature sensor in the form of an infrared sensor 116 is located on the top wall 98 of the movable portion 94. Preferably, the infrared sensor 116 is positioned on the top wall 98 such that it can sense the temperature of the contents within the cup 90.

The alternative configuration shown in FIG. 5B is similar to the configuration shown in FIG. 5A, except that the peripheral wall 80 does not extend to or beyond the upper end of the cup 90 and the seal only comprises the choke 112, which is formed in the base 92.

A temperature sensor in the form of a temperature probe 118 extends from the top wall 98 of the movable portion 94. Preferably, the temperature probe 118 is of a length that it will extend into the cup 90 a sufficient distance to contact the contents of the cup therein. The temperature probe 118 can be mounted to the movable portion 94 in such a manner that it is withdrawn when the cover is opened and extends as shown in FIG. 5B only when the cover is closed.

The cup warmer cooking cavity construction illustrated in FIG. 5A provides better support for the cup 90 than the configuration shown in FIG. 5B since the peripheral wall 80 extends substantially along the entire height of the cup 90 as compared to the height of the peripheral wall 80 in FIG. 5B. However, the cup warmer cooking cavity configuration of FIG. 5B provides the user with more convenient access to the cup 90 than the configuration of FIG. 5A. Since the upper end of the cup 90 extends above the peripheral wall 80 in the configuration of FIG. 5B, it is much easier for the user to grasp the rim of the cup and lift the cup from the cavity 48.

FIGS. 5A and 5B only show two possible configurations for the cooking cavity 48. The ratio of the peripheral wall 80 and the peripheral wall 100 for the base 92 and the cover 94, respectively, can be varied as need be or desired. In effect, the cooking cavity 48 can be formed both by one or both of the base 92 and the cover 94.

Although not shown, an open-door sensor can be incorporated into one of the movable portion 94 or the base 92. Preferably, such an open-door sensor would comprise a switch mounted to one of the movable portion 94 and base portion 92, which contacts the other of the movable portion 94 and base portion 92. The opening and closing of the movable portion relative to the base will result in a change in status of the switch thereby indicating whether the movable portion is closed. The open-door sensor can be used to prevent the sending of microwaves to the cooking cavity 48 when the cover 50 is opened.

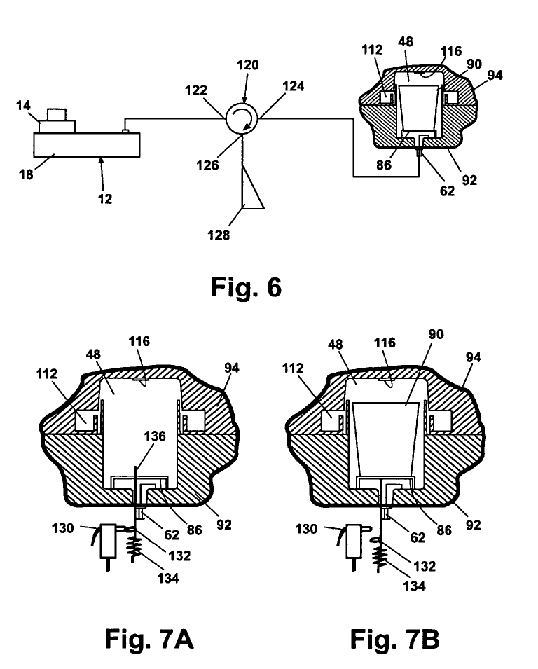

FIGS. 6 and 7 illustrate load sensors for use with the distributed microwave system 12 to indicate the existence of a load within the cooking cavity 48. If there is no load in the cooking cavity 48, it is desirable not to transmit microwaves into the cooking cavity as they may damage the material forming the cooking cavity. In the context of a cup warmer as illustrated in FIGS. 6 and 7, the load sensors are used to determine whether the cup 90 contains a sufficient amount of beverage such that microwaves can be introduced into the cooking cavity 48 without its damage.

In FIG. 6, the load sensor comprises a circulator 120 having an inlet port 122, an outlet port 124, a dummy port 126. The inlet and outlet ports 122, 124 are connected in line to the coaxial cable 62. The dummy port 126 is connected to a dummy load 128 having a temperature sensor.

When microwaves are transmitted down the coaxial cable 62 they enter the circulator 120 at the inlet port 122 where they exit at the outlet port 124, and are received within the cooking cavity 48. The microwaves that are not absorbed by the load in the cup 90 exit the cooking cavity 48 through the external conductor of the coaxial cable 62 where they re-enter the circulator 120 through the outlet port 124. The circulator 120 directs the returning microwaves down the dummy port 126 to the dummy load 128. The microwaves raise the temperature of the dummy load 128. The temperature increase in the dummy load is monitored by its temperature sensor. The change in temperature of the dummy load 128 is indicative of the quantity of microwaves not absorbed by the load within the cup 90, which can be used to determine whether the load in the cup 90 is sufficient for the microwaves to be safely introduced into the cooking cavity. Preferably, the control wall will have a safety setting where once the temperature of the dummy load crosses a threshold temperature, no further transmission of microwaves to the cooking cavity 48 will be permitted.

FIGS. 7A and 7B illustrate an alternative load sensor in the form of a weight sensor that determines the weight of the container 90 and its contents. If the weight of the container 90 and its contents exceed a threshold value, then it is safe for microwaves to be introduced into the cooking cavity 48 without damage.

As illustrated, the weight sensor comprises a switch having one fixed contact 130 and one movable contact 132. The movable contact 132 is mounted to a compressible spring 134. The spring has a tip 136 and extends into the cavity 48 beyond the cup support 86. When there is no cup 90 resting on the cup support 86, the tip 136 of the spring 134 will be in its naturally extended position and the moveable contact 132 will be in physical contact with the fixed contact 130, placing the switch in the closed position and thereby indicating that no load exists within the cooking cavity 48. However, as illustrated in FIG. 7B, when a cup is placed within the cooking cavity 48 and on the cup support 86, the bottom of the cup will contact the tip 136 of the compressible spring 134. The weight of the cup 90 and its contents will compress the compressible spring 134 moving axially downwardly to thereby move the movable contact 132 out of physical contact with the fixed contact 130 to open the switch. The open state of the switch indicates that a cup is positioned within the cooking cavity 48 and that it is safe to introduce microwaves into the cooking cavity 48.

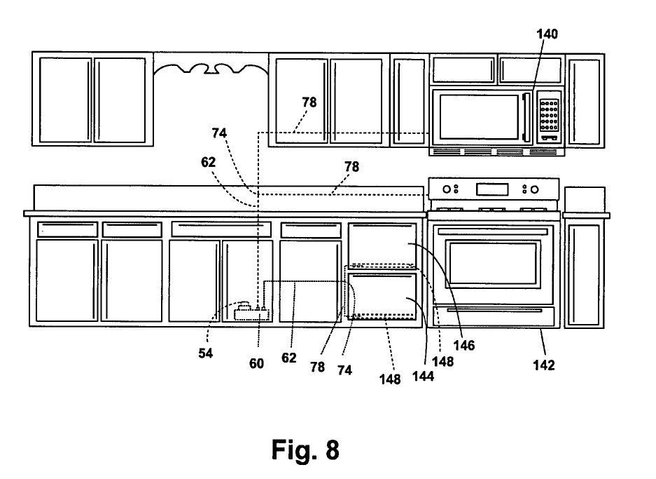

While the preferred implementation of the distributed microwave system in accordance with the invention is in the environment of a vehicle as described above, the distributed microwave system is applicable to other environments. FIG. 8 illustrates one such alternative environment, which is a traditional kitchen having appliances comprising a microwave oven 140, a oven/range 142 with microwave, and warming drawers 144, 146. All of these traditional appliances can be supplied microwaves from the distributed microwave system 12 according to the invention.

Preferably, the distributed microwave system 12 is built in and located within the cabinet structure and walls of the kitchen. The microwave generator 14 and waveguide 60 are preferably located within one of the cabinets in a position that is out of sight, yet is still accessible by the user for service as need be. Coaxial cables 62 extend from the waveguide 60 and each has a switch 74, from which extends feeder coaxial cables 78 that are coupled to appliances.

For example, one of the coaxial cables 62 splits into two feeder coaxial cables 78, one of which feeds the microwaves to the traditional microwave oven 140 and the other feeds microwaves to a traditional oven/range 142, which includes a combination oven/microwave oven. The other coaxial cable 62 has a switch 74 that divides into two feeder coaxial cables 78, which are connected to heating elements 148 located within the bottoms of the warming drawers 144 and 146, respectively.

With this configuration, a single source of microwaves can be used to supply multiple microwave-using appliances within the kitchen. The use of a single microwave source reduces the complexity of each of the appliances which would otherwise need their own independent source. The moving of the microwave generator from the appliance to a remote location frees up space in each of the appliances that would otherwise be occupied by the individual microwave generators. This available space can be used to increase the capacity of the appliances or to provide for additional functionality, both of which are highly desirable by the user.

Alternatively, each of the cooking elements could have a dedicated microwave generator, similar to the configuration shown in FIGS. 1 and 2. Multiple microwave generators would be more appropriate if it is contemplated that the cooking elements would be used simultaneously and reduced power was not desired.

While the invention has been specifically described in connection with certain specific embodiments thereof, it is to be understood that this is by way of illustration and not of limitation, and the scope of the appended claims should be construed as broadly as the prior art will permit.

1. A distributed microwave cooking system, comprising:

2. a microwave generator having an output for providing a single source of microwave energy;

3. multiple cooking elements located remotely from the microwave generator;

4. a microwave conduit connecting each of the cooking elements to the microwave generator;

5. wherein the microwave energy generated by the microwave generator is distributed to the multiple cooking elements through the microwave conduits.

6. The distributed microwave cooking system according to claim 1, wherein the microwave conduit comprises a coaxial cable carrying the microwaves from the microwave generator to at least one of the cooking elements.

7. The distributed microwave cooking system according to claim 2, wherein the microwave conduit further comprises a waveguide connected to the output of the microwave generator and to one end of the coaxial cable to direct the microwaves from the microwave generator to the coaxial cable for distribution to the at least one of the cooking elements.

8. The distributed microwave cooking system according to claim 3, wherein the microwave conduit further comprises a switch attached to the other end of the coaxial cable, and the switch has multiple outputs to thereby switch the microwaves passing through the coaxial cable amongst the multiple outputs.

9. The distributed microwave cooking system according to claim 4, wherein the microwave conduit further comprises multiple feeder coaxial cables for connecting the switch outputs to the cooking elements.

10. The distributed microwave cooking system according to claim 5, wherein there is a feeder coaxial cable for each of the cooking elements.

11. The distributed microwave cooking system according to claim 3, wherein there are multiple coaxial cables and each coaxial cable connects a different cooking element to the waveguide.

12. The distributed microwave cooking system according to claim 7, wherein the waveguide comprises multiple channels and each channel corresponds to one of the coaxial cables.

13. The distributed microwave cooking system according to claim 3, wherein the coaxial cable has an inner conductor that extends into a channel formed in the interior of the waveguide to permit the transmission of the microwaves from the microwave generator, through the waveguide, and into the inner conductor.

14. The distributed microwave cooking system according to claim 9, wherein the portion of the inner conductor extending into the waveguide is tapered.

15. The distributed microwave cooking system according to claim 10, wherein the portion of the inner conductor extending into the waveguide is spaced ¼ of a wavelength of the microwaves upstream from an end of the waveguide.

16. The distributed microwave cooking system according to claim 11, and further comprising an impedance tuner located within the channel upstream of the portion of the inner conductor extending into the waveguide.

17. The distributed microwave cooking system according to claim 1, wherein at least one of the cooking elements is a cooking cavity.

18. The distributed microwave cooking system according to claim 13, and further comprising a housing defining an open-face recess forming the cooking cavity, and a door moveably mounted to the housing for selectively closing the open-face recess.

19. The distributed microwave cooking system according to claim 14, wherein the housing and the door define a microwave choke to prevent the escape of microwaves from the cavity when the door is closed.

20. The distributed microwave cooking system according to claim 1, wherein at least one of the cooking elements comprises a microwave lossy heating element that is coupled to the microwave generator by the microwave conduit resulting in the heating of the heating element in response to the receipt of the microwaves.

21. The distributed microwave cooking system according to claim 16, wherein at least one of the cooking elements is a warming drawer and the heating element is located within the warming drawer.

22. The distributed microwave cooking system according to claim 17, wherein the warming drawer comprises bottom, front, rear, left, and right walls, with one of the walls forming the heating element.

23. The distributed microwave cooking system according to claim 1, wherein the microwave generator is a magnetron.

24. The distributed microwave cooking system according to claim 1, wherein the microwave generator is a solid-state microwave generator.

25. A vehicle in combination with a distributed microwave cooking system, comprising:
a microwave cooking element located within the vehicle and accessible by a user of the vehicle;
a microwave generator located within the vehicle and remotely spaced from the microwave cooking element; and
a microwave conduit connecting the microwave generator to the microwave cooking element such that the microwaves generated by the microwave generator are directed to the microwave cooking element through the microwave conduit to cook an item with the microwave cooking element.

26. The combination of claim 21, wherein the microwave conduit comprises a coaxial cable carrying the microwaves from the microwave generator to the cooking element.

27. The combination of claim 22, wherein the microwave conduit further comprises a waveguide connected to the output of the microwave generator and to one end of the coaxial cable to direct the microwaves from the microwave generator to the coaxial cable for distribution to the cooking element.

28. The combination of claim 23, and further comprising multiple microwave cooking elements located in the vehicle.

29. The combination of claim 24, wherein the microwave conduit further comprises a switch attached to the other end of the coaxial cable, and the switch has multiple outputs to thereby switch the microwaves passing through the coaxial cable amongst the multiple outputs and the microwave conduit further comprises multiple feeder coaxial cables for connecting the switch outputs to the cooking elements to thereby distribute the microwaves from the microwave generator to the multiple cooking elements.

30. The combination of claim 25, wherein there is a feeder coaxial cable for each of the cooking elements.

31. The combination of claim 24, wherein there are multiple coaxial cables and each coaxial cable connects a different cooking element to the waveguide.

32. The combination of claim 27, wherein the waveguide comprises multiple channels and each channel corresponds to one of the coaxial cables.

33. The combination of claim 21, wherein the vehicle comprises a passenger compartment and the microwave cooking element is located within the passenger compartment.

34. The combination of claim 29, wherein the microwave generator is located within the passenger compartment.

35. The combination of claim 29, wherein the vehicle comprises a storage area and the microwave generator is located in the storage area.

36. The combination of claim 31, wherein the vehicle comprises a trunk that defines the storage area.

37. The combination of claim 21, wherein the passenger compartment comprises a console having a selectively closeable cavity forming the cooking element.

38. The combination of claim 33, wherein the passenger compartment comprises spaced front seats with the console is located between the spaced front seats.

39. The combination of claim 34, wherein the passenger compartment comprises a dash and a second cooking element is located in the dash and connected to the microwave generator by the microwave conduit.

40. The combination of claim 35, wherein the dash comprises a glovebox defining a selectively closeable cavity forming the second cooking element.

41. The combination of claim 21, wherein the cooking element comprises a housing having an open-top recess defining a cooking cavity sized to receive a cup, and a cover movably mounted to the housing for selectively closing the open-top cooking cavity with the cup positioned within the cavity, wherein the housing is located within the passenger compartment such that it is accessible by a user of the vehicle.

42. The combination of claim 37, wherein the cooking cavity comprises a cup support on which the bottom of the cup will rest when the cup is placed within the cooking cavity.

43. The combination of claim 38, wherein the microwave conduit comprises a coaxial cable having one end coupled to the microwave generator and an other end coupled to the cooking cavity to deliver the microwaves from the microwave generator to the cooking cavity.

44. The combination of claim 39, wherein the coaxial cable has an inner conductor with a portion that extends into the cooking cavity to form an antenna for transmitting the microwaves into the cooking cavity for direct contact with the cup.

45. The combination of claim 40, wherein the antenna is located beneath the cup support.

46. The combination of claim 39, and further comprising a heating element located within cooking cavity, the heating element being made from a microwave lossy material and directly connected to the other end of the coaxial cable such that the microwaves heat the heating element to introduce heat into the cooking cavity.

47. The combination of claim 42, wherein the heating element forms the cup support.

48. The combination of claim 37, and further comprising a temperature sensor located in the cooking cavity for determining the temperature of the contents of the cup.

49. The combination of claim 44, wherein the temperature sensor is an infrared sensor located on the cover such that the infrared sensor overlies the top of a cup positioned within the cooking cavity when the cover closes the cooking cavity.

50. The combination of claim 44, wherein the temperature sensor is a temperature probe that extends into the open top of a cup positioned within the cooking cavity when the cover closes the cooking cavity.

51. The combination of claim 37, and further comprising a load sensor for determining if a cup placed within the cooking cavity has a threshold volume of liquid.

52. The combination of claim 47, wherein the load sensor is weight sensor that detects a threshold weight for the load.

53. The combination of claim 47, wherein the load sensor comprises an excess microwave sensor for detecting the microwaves not absorbed by the contents of the cup.

54. The combination of claim 37, wherein the cover defines an open-bottom recess and the combination of the housing open-top recess and the cover open-bottom recess define the cooking cavity.

55. A microwave cup warmer for a vehicle, comprising:
a microwave cooking element for warming the contents of a cup;
a microwave generator located remotely from the microwave cooking element; and
a microwave conduit connecting the microwave generator to the microwave cooking element such that the microwaves generated by the microwave generator are directed to the microwave cooking element through the microwave conduit to cook an item with the microwave cooking element.

56. The microwave cup warmer of claim 51, wherein the cooking element comprises a housing having an open-top recess defining a cooking cavity sized to receive a cup, and a cover movably mounted to the housing for selectively closing the open-top cooking cavity with the cup positioned within the cavity.

57. The microwave cup warmer of claim 52, wherein the cooking cavity comprises a cup support on which the bottom of the cup will rest when the cup is placed within the cooking cavity.

58. The microwave cup warmer of claim 53, wherein the microwave conduit comprises a coaxial cable having one end coupled to the microwave generator and an other end coupled to the cooking cavity to deliver the microwaves from the microwave generator to the cooking cavity.

59. The microwave cup warmer of claim 54, wherein the coaxial cable has an inner conductor with a portion that extends into the cooking cavity to form an antenna for transmitting the microwaves into the cooking cavity for direct contact with the cup.

60. The microwave cup warmer of claim 55, wherein the antenna is located beneath the cup support.

61. The microwave cup warmer of claim 56, and further comprising a heating element located within cooking cavity, the heating element being made from a microwave lossy material and directly connected to the other end of the coaxial cable such that the microwaves heat the heating element to introduce heat into the cooking cavity.

62. The microwave cup warmer of claim 57, wherein the heating element forms the cup support.

63. The microwave cup warmer of claim 54, wherein the microwave conduit further comprises a waveguide having one portion connected to the microwave generator and another portion connected to the one end of the coaxial cable to couple the coaxial cable to the microwave generator.

64. The microwave cup warmer of claim 59, wherein the coaxial cable has an inner conductor with a portion that extends into a channel formed in the interior of the waveguide to permit the transmission of the microwaves from the microwave generator, through the waveguide, and into the inner conductor.

65. The microwave cup warmer of claim 60, wherein the portion of the inner conductor extending into the waveguide is tapered.

66. The microwave cup warmer of claim 61, wherein the portion of the inner conductor extending into the waveguide is spaced ¼ of a wavelength of the microwaves upstream from an end of the waveguide.

67. The microwave cup warmer of claim 62, and further comprising an impedance tuner located within the channel upstream of the portion of the inner conductor extending into the waveguide.

68. The microwave cup warmer of claim 52, and further comprising a temperature sensor located in the cooking cavity for determining the temperature of the contents of the cup.

69. The microwave cup warmer of claim 64, wherein the temperature sensor is an infrared sensor located on the cover such that the infrared sensor overlies the top of a cup positioned within the cooking cavity when the cover closes the cooking cavity.

70. The microwave cup warmer of claim 64, wherein the temperature sensor is a temperature probe that extends into the open top of a cup positioned within the cooking cavity when the cover closes the cooking cavity.

71. The microwave cup warmer of claim 52, and further comprising a load sensor for determining if a cup placed within the cooking cavity has a threshold volume of liquid.

72. The microwave cup warmer of claim 67, wherein the load sensor is weight sensor that detects a threshold weight for the load.

73. The microwave cup warmer of claim 68, wherein the load sensor comprises an excess microwave sensor for detecting the microwaves not absorbed by the contents of the cup.

74. The microwave cup warmer of claim 52, wherein the cover defines an open-bottom recess and the combination of the housing open-top recess and the cover open-bottom recess define the cooking cavity.
